(19) United States
(12) Patent Application Publication
(10) Pub. No.: US 2006/0207364 A1
(43) Pub. Date: Sep. 21, 2006

(54) Pressure-measuring appliance for a hydraulic or pneumatic adjusting device in an automatic transmission or an automated transmission

(76) Inventor: Karl-Fritz Heinzelmann, Meckenbeuren (DE)

Correspondence Address: DAVIS & BUJOLD, P.L.L.C., 112 PLEASANT STREET, CONCORD, NH, 03301, US

(21) Appl. No.: 11/376,906

(22) Filed: Mar. 16, 2006

(30) Foreign Application Priority Data
Mar. 17, 2005 (DE) 102005012259.0

(51) Int. Cl. F16H 61/00

(52) U.S. Cl. 74/335

(57) ABSTRACT

A pressure-measuring appliance for a hydraulic or pneumatic adjusting device in an automatic transmission or an automated transmission. The adjusting device has at least one actuating cylinder (3, 3′) and one shift valve (2, 2′) coordinated with the actuating cylinder (3, 3′). For each actuating cylinder (3, 3′), one pressure sensor (1, 1′) is situated between the actuating cylinder (3, 3′) of the adjusting device and the shift valve (2, 2′) coordinated with the actuating cylinder (3, 3′).

This application claims priority from German Application Serial No. 10 2005 012 259.0 filed Mar. 17, 2005.

### FIELD OF THE INVENTION

The invention concerns a pressure-measuring appliance for a hydraulic or pneumatic adjusting device in an automatic transmission or an automated transmission and a method for pressure measuring in automatic transmissions or automated transmissions.

### BACKGROUND OF THE INVENTION

EP 1 067 319 B1 discloses an appliance to control an adjusting device for a transmission wherein the adjusting device has one first pressure medium chamber and one second pressure medium chamber divided from each other by a piston movable in direction of the longitudinal axis thereof. For each pressure medium chamber one first and one second controllable valve is provided by way of which the pressure medium chambers can be optionally connected with the pressure medium source or with the pressure medium sink. One electric control device is provided for the control of the first and second valve devices.

The appliance for control of an adjusting device further comprises one third controllable valve device which serves as a shut-off valve and one pressure-sensor device connected with the electric control device by way of which can be measured the pressure in the first and the second pressure chambers. In this manner, at least one of the controllable valve devices is controlled depending on the signals of the pressure-sensor device. The sensor signal is used to regulate the pressure or to monitor the supply pressure. The pressure-sensor device is preferably situated before the first and the second controllable valve device.

In automated transmissions, the system pressure is usually adjusted, via a pressure-limiting valve. It is well known to locate a pressure sensor for pressure monitoring after the pressure-limiting valve and before the control valves.

The problem on which this invention is based is to outline a pressure-measuring appliance for hydraulic or pneumatic adjusting devices in an automatic transmission or an automated transmission which directly makes measuring the pressure in the operation area possible. In addition, a pressure-measuring method is to be outlined for adjusting devices in automatic transmissions and automated transmissions.

### SUMMARY OF THE INVENTION

Accordingly, a pressure-measuring appliance is proposed for a hydraulic or pneumatic adjusting device in an automatic transmission or an automated transmission in which the adjusting device has at least one actuating cylinder and one shift valve coordinated with the actuating cylinder, comprising at least one pressure sensor located between the shift valve and one actuating cylinder of the adjusting device.

In this manner, the pressure can be measured and accordingly regulated via the transmission control directly in the operation area, namely, between the actuating cylinder and the shift valve. The pressure can be advantageously regulated via clocked control valves or a regulatable pressure-limiting valve.

For the case that the adjusting device comprises several actuating cylinders, the advantage is provided for each actuating cylinder; one pressure sensor located between the respective actuating cylinder and the shift valve coordinated with the actuating cylinder.

The inventive appliance for pressure measuring can be introduced in the adjusting device for shifting the gears of a main transmission of a front-mounted splitter group or of a planet rear-mounted range change group. It can also be advantageously used to select the gates, to actuate the transmission brake or to control a clutch or a shift element.

### BRIEF DESCRIPTION OF THE DRAWING

The invention will now be described, by way of example, with reference to the-accompanying drawings in which:

FIG. 1 diagrammatically shows the arrangement of a pressure sensor within an adjusting device.

### DETAILED DESCRIPTION OF THE INVENTION

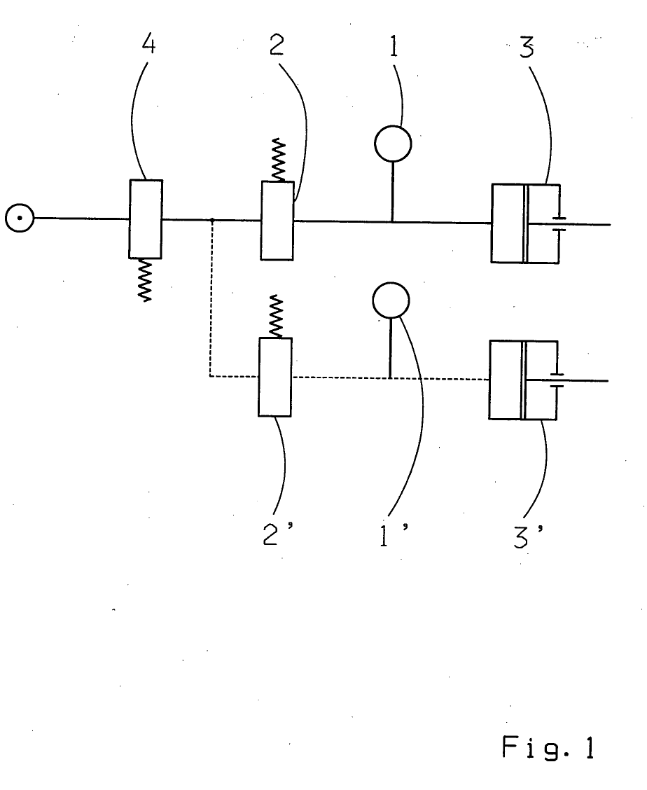

It is to be appreciated from FIG. 1 that an inventive pressure-measuring appliance comprises one pressure sensor 1 located between a shift valve 2 and an actuating cylinder 3 of the adjusting device. For the case that several actuating cylinders are provided, one pressure sensor 1′ is situated between a respective actuating cylinder 3′ and a shift valve 2′ coordinated with the actuating cylinder 3′.

According to the invention, at least one pressure sensor 1, 1′ is connected with the transmission control or with a control device in which the sensor signals are evaluated. In the FIGURE, a main shut-off valve is provided with a reference numeral 4.

By way of an inventive draft, the pressure can be advantageously measured and accordingly regulated in the operation area between the actuating cylinder 3 and the shift valve 2. The pressure is regulated via clocked control valves or via a regulatable pressure-limiting valve.

Any structural design, specifically any spatial arrangement of the pressure sensor and of the elements of the adjusting device, or relative to each other and insofar as technically relevant, obviously also falls under the scope of protection of the instant claims without affecting the function of the pressure-measuring appliance such as outline in the claims even if those designs have not been explicitly shown in the FIGURE or in the description.

### REFERENCE NUMERALS

1 pressure sensor
1′ pressure sensor
2 shift valve
2′ shift valve
3 actuating cylinder
3′ actuating cylinder
4 main shut-off valve

1-4. (canceled)

5. A pressure-measuring appliance for one of a hydraulic and a pneumatic adjusting device in one of an automatic transmission and an automated transmission, the adjusting device having at least one actuating cylinder and one shift valve coordinated with the at least one actuating cylinder, for each actuating cylinder (3, 3′) a pressure sensor (1, 1′) is situated between the actuating cylinder (3, 3′) of the adjusting device and a shift valve (2, 2′) which is coordinated with the actuating cylinder (3, 3′).

6. The pressure-measuring appliance according to claim 5, wherein the pressure sensor (1, 1′) is connected with one of a transmission control and a control device to which pressure sensor signals are sent and evaluated.

7. A pressure-measuring method for one of a hydraulic and a pneumatic adjusting device in one of an automatic transmission and an automated transmission, the adjusting device has at least one actuating cylinder and one shift valve coordinated with the actuating cylinder, and the method comprising the step of:
measuring pressure, in an area between the actuating cylinder (3, 3′) of the adjusting device and the shift valve (2, 2′) which is coordinated with the actuating cylinder (3, 3′), via at least one sensor (1, 1′).

8. The pressure-measuring method according to claim 7, further comprising the step of transmitting signals of the pressure measured by the at least one sensor (1, 1′) to one of a transmission control and a control device, and using the transmitted signals for pressure regulation via one of clocked control valves and a regulatable pressure-limiting valve.
